(19) United States
(12) Patent Application Publication
(10) Pub. No.: US 2025/0104487 A1
(43) Pub. Date: Mar. 27, 2025

(54) ABNORMAL CONDITION DETECTION SYSTEM, ABNORMAL CONDITION DETECTION METHOD, AND ABNORMAL CONDITION DETECTION RECORDING MEDIUM

(71) Applicant: LAPIS Technology Co., Ltd., Yokohama (JP)

(72) Inventors: Naoki NISHITANI, Yokohama (JP); Yuki IMATOH, Yokohama (JP)

(73) Assignee: LAPIS Technology Co., Ltd., Yokohama (JP)

(21) Appl. No.: 18/896,900

(22) Filed: Sep. 26, 2024

(30) Foreign Application Priority Data
Sep. 27, 2023 (JP) 2023-166421

(51) Int. Cl. G07C 5/02; G10L 25/51; G10L 25/90

(52) U.S. Cl. CPC G07C 5/02; G10L 25/51; G10L 25/90

(57) ABSTRACT

An abnormal condition detection system includes a voice abnormality detector that includes a normal time model generator for generating a model of normal time voice data of a person riding in a vehicle as a normal time model based on voice data including voice of the person, and detects an abnormality in the voice based on a current voice data of the person and the normal time model; a vehicle body abnormality detector that detects an abnormality in a vehicle body of the vehicle based on acceleration data of the vehicle; and an abnormal condition determiner that determines whether or not the vehicle is in an abnormal condition based on a detection result of the voice abnormality detector and a detection result of the vehicle body abnormality detector.

### CROSS-REFERENCE TO RELATED APPLICATION

This application claims the priority benefits of Japanese application no. 2023-166421, filed on Sep. 27, 2023. The entity of the above-mentioned patent application is hereby incorporated by reference herein and made a part of this specification.

### BACKGROUND

### Technical Field

The disclosure relates to an abnormal condition detection system, an abnormal condition detection method, and an abnormal condition detection recording medium.

### Related Art

Generally, techniques for detecting an abnormal condition of a vehicle, such as an accident, are known. Another known technique for this purpose is to detect the occurrence of an accident by detecting the screams of a person in a vehicle. for example, Patent Document 1 (Japanese Patent Laid-open No. 2017-187676) describes a technology in which a model of a scream is prepared in advance, which is a model learned from the feature amount of multiple types of screams, and whether or not an input voice is a scream is determined based on the feature amount extracted from the input voice, an acoustic model set, and the likelihood.

However, when preparing scream data in advance as in the technology described in Patent Document 1, data of various scream must be prepared, resulting in a large amount of data. Further, screams that had not been prepared in advance could not be recognized as screams. Thus, conventional techniques are not sufficient for detecting abnormal conditions in a vehicle.

The disclosure aims to provide an abnormal condition detection system, an abnormal condition detection method, and an abnormal condition detection program capable of detecting an abnormal condition in a vehicle without preparing scream data in advance.

### SUMMARY

The abnormal condition detection system disclosed herein includes a voice abnormality detector that includes a normal time model generator for generating a model of normal time voice data of a person riding in a vehicle as a normal time model based on voice data including voice of the person, and detects an abnormality in the voice based on a current voice data of the person and the normal time model; a vehicle body abnormality detector that detects an abnormality in a vehicle body of the vehicle based on acceleration data of the vehicle; and an abnormal condition determiner that determines whether or not the vehicle is in an abnormal condition based on a detection result of the voice abnormality detector and a detection result of the vehicle body abnormality detector.

The abnormal condition detection method disclosed herein uses a processor included in an abnormal condition detection system, generates a model of normal time voice data of a person riding in a vehicle as a normal time model based on voice data including voice of the person, and detects an abnormality in the voice based on a current voice data of the person and the normal time model; detects an abnormality in a vehicle body of the vehicle based on acceleration data of the vehicle; and outputs, based on a detection result of the abnormality in the voice and a detection result of the abnormality in the vehicle body, a determination result as to whether or not the vehicle is in an abnormal condition.

The abnormal condition detection recording medium, recording a program disclosed herein is configured to cause a processor included in an abnormal condition detection system perform the following processing: generating a model of normal time voice data of a person riding in a vehicle as a normal time model based on voice data including voice of the person, and detecting an abnormality in the voice based on a current voice data of the person and the normal time model; detecting an abnormality in a vehicle body of the vehicle based on acceleration data of the vehicle; and outputting, based on a detection result of the abnormality in the voice and a detection result of the abnormality in the vehicle body, a determination result as to whether or not the vehicle is in an abnormal condition.

### BRIEF DESCRIPTION OF THE DRAWINGS

FIG. 1 is a diagram for illustrating an overview of an abnormal condition detection system.

FIG. 2 is a circuit diagram showing an example of a hardware configuration of the abnormal condition detection system.

FIG. 3 is a diagram illustrating an example of a configuration of an abnormal condition detection system.

FIG. 4 is a diagram for illustrating the function of the abnormal condition detection system.

FIG. 5 is a diagram for illustrating a data frequency and data accumulation level measurer.

FIG. 6 is a flowchart showing an example of the flow of an abnormal condition detection processing.

FIG. 7 is a flowchart showing an example of the flow of a voice abnormality detection processing.

FIG. 8 is a flowchart showing an example of the flow of a vehicle body abnormality detection processing.

### DESCRIPTION OF THE EMBODIMENTS

Hereinafter, embodiments of the disclosure will be described in detail with reference to the drawings. Note that the following embodiments do not limit the technology of the disclosure.

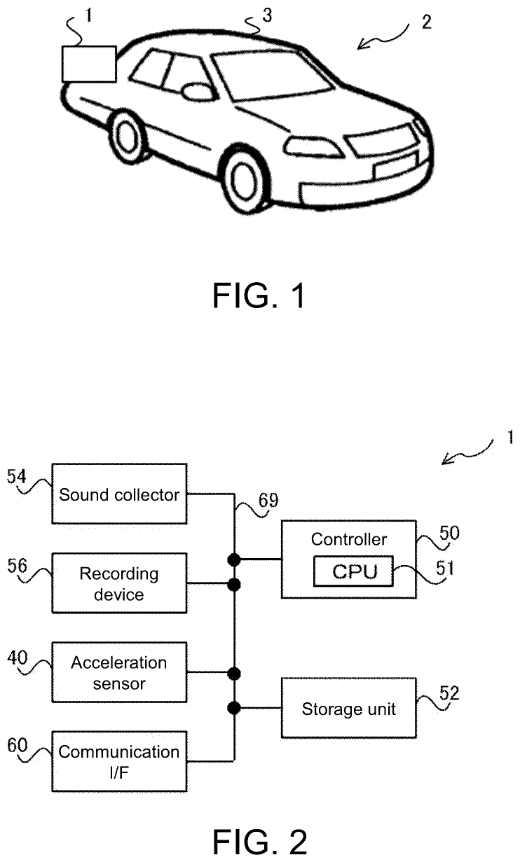

As shown in FIG. 1, an abnormal condition detection system 1 of the embodiment is provided inside a vehicle body 3 of a vehicle 2. The abnormal condition detection system 1 is a system that determines whether or not the vehicle 2 is in an abnormal condition based on an abnormality in the voice of a person riding in the vehicle 2 and an abnormality in the vehicle body 3. In this embodiment, “person riding in the vehicle 2” specifically refers to all people present inside the vehicle body 3, including people other than the driver.

FIG. 2 shows an example of a hardware configuration of the abnormal condition detection system 1 of this embodiment. As shown in FIG. 2, the abnormal condition detection system 1 of the embodiment includes an acceleration sensor 40, a controller 50, a storage unit 52, a sound collector 54, a recording device 56, and a communication I/F (Interface) 60. The acceleration sensor 40, the controller 50, the storage unit 52, the sound collector 54, the recording device 56, and the communication I/F 60 are connected via a bus 69 such as a system bus or a control bus so as to be able to transmit and receive various information to and from each other.

The controller 50 includes a CPU (Central Processing Unit) 51 and controls the entire abnormal condition detection system 1. The CPU 51 of the embodiment is an example of a processor of the disclosure.

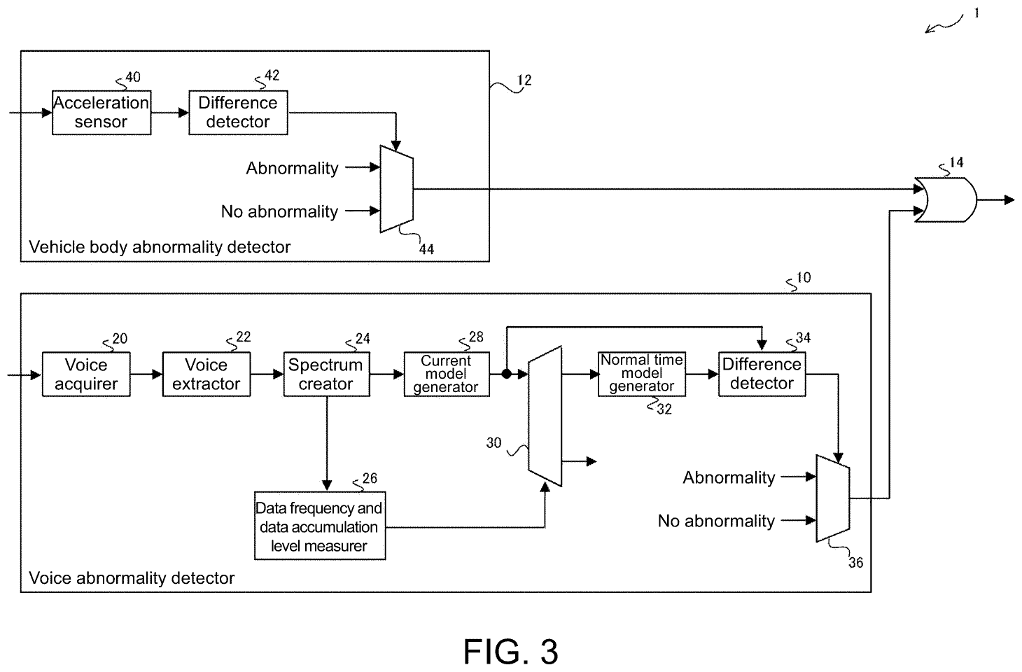

The storage unit 52 stores the voice of a person riding in the vehicle 2, or a current model generator 28 and a display region 62 (see FIG. 3 for both), which will be described in detail later. The storage unit 52 is realized by a storage medium such as a hard disk drive (HDD), a solid state drive (SSD), or a flash memory.

The sound collector 54 has a function of collecting the voice of a person riding in the vehicle 2, and is, for example, a microphone. The recording device 56 has a function of recording the sound collected by the sound collector 54, and the recorded sound is stored in the storage unit 52. Moreover, the acceleration sensor 40 has a function of detecting the acceleration of the vehicle body 3 of the vehicle 2.

The communication I/F 60 communicates various types of information with devices external to the abnormal condition detection system 1 or devices external to the vehicle 2 via wireless communication or wired communication.

Further, the configuration of the abnormal condition detection system 1 of this embodiment will be described with reference to FIG. 3. As shown in FIG. 3, the abnormal condition detection system 1 of the embodiment includes a voice abnormality detector 10, a vehicle body abnormality detector 12, and an abnormal condition determiner 14.

The voice abnormality detector 10 includes a voice acquirer 20, a voice extractor 22, a spectrum creator 24, a data frequency and data accumulation level measurer 26, the current model generator 28, a multiplexer 30, a normal time model generator 32, a difference detector 34, and a multiplexer 36.

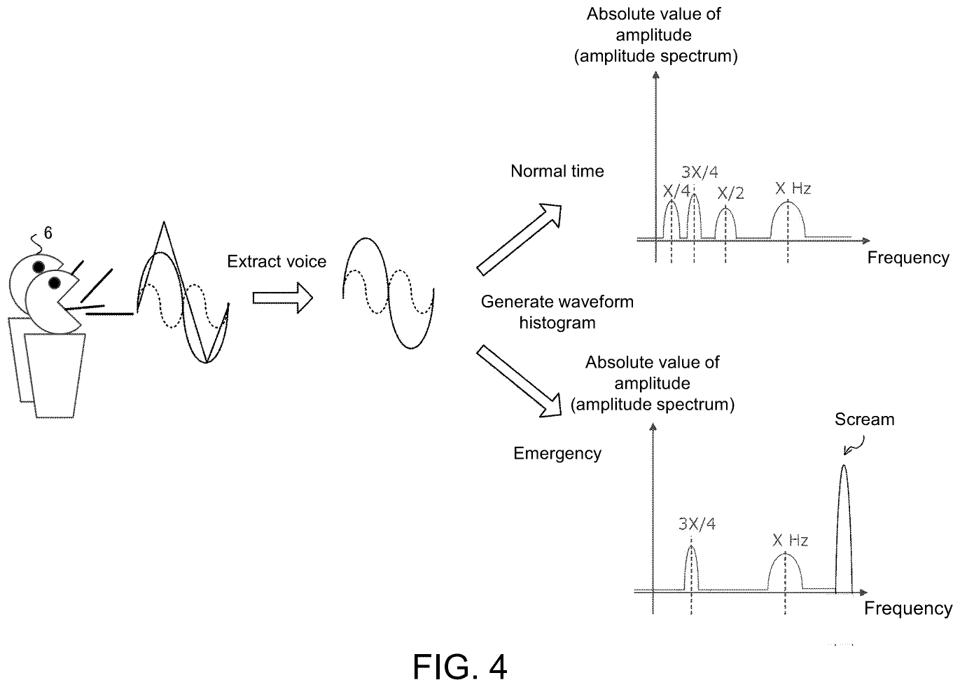

The voice acquirer 20 includes the above-mentioned sound collector 54 and the recording device 56. The voice acquirer 20 has a function of acquiring voice data including the voice of a person 6 riding in the vehicle 2 as shown in FIG. 4. In reality, the sounds collected by the sound collector 54 of the voice acquirer 20 include sounds other than the voice produced by the person 6 riding in the vehicle 2. Sounds other than the voice produced by the person 6 include sounds produced by the vehicle 2 itself, environmental sounds, and the like. In this embodiment, among the sounds collected by the sound collector 54 of the voice acquirer 20, sounds other than the voice of the person 6 are referred to as “noise.”

The voice extractor 22 has a function of extracting voice data of the person 6 riding in the vehicle 2 from the voice data acquired by the voice acquirer 20. In other words, the voice extractor 22 has a function of removing noise from the voice data acquired by the voice acquirer 20. The method for extracting the voice of the person 6, i.e., human voice, from the voice data acquired by the voice extractor 22 is not particularly limited, and any known method may be used. For example, a filter that passes only human voice frequencies may be applied.

The spectrum creator 24 has a function of creating a waveform histogram for the voice data output from the voice extractor 22. Moreover, the method by which the spectrum creator 24 generates the waveform histogram is not particularly limited, and any known method may be used. For example, a waveform histogram may be generated by performing a Fast Fourier transform (FFT) or a Discrete Fourier transform (DFT) on the voice data. This allows the frequency characteristics of the voice data to be known, and the features of the voice data to be clarified. As shown in FIG. 4, the waveform histogram of normal time voice data and the waveform histogram in an emergency such as an accident have different features. The frequency of the voice data corresponds to the pitch of the voice, and the amplitude corresponds to the loudness of the voice. As shown in FIG. 4, the waveform histogram in normal times contains many waveforms with relatively small amplitudes and relatively low frequencies. On the other hand, a scream tends to be louder and higher in pitch than a normal voice. Thus, during an emergency, waveforms with large amplitude and high frequency are included. In this way, when the waveform histogram contains features that deviate significantly from the features contained in the waveform histogram in normal times, it may be determined that the voice data contains a scream.

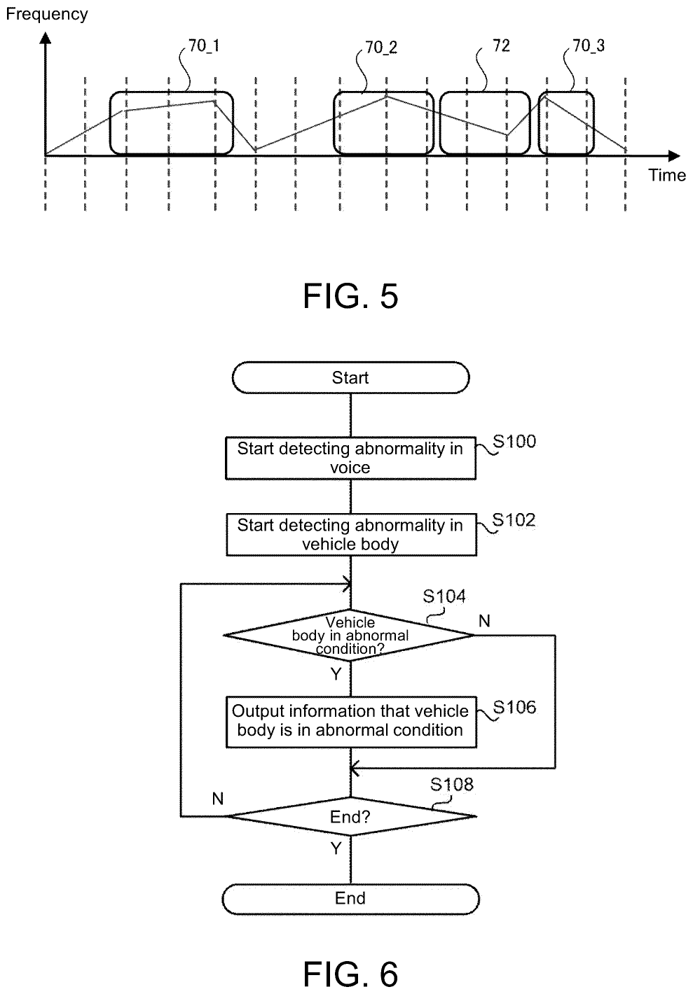

The data frequency and data accumulation level measurer 26 has a function of measuring the frequency and accumulation level of voice data. The data frequency and the data accumulation level measurer 26 measures the frequency and accumulation level of voice data to determine whether or not the voice data is correct and sufficient. The data frequency and data accumulation level measurer 26 of this embodiment divides interval by each predetermined time, measures the data frequency for each interval, and adopts the interval in which the data frequency is higher than a predetermined threshold as the valid period of the voice data. In the example shown in FIG. 5, periods 70_1, 70_2, and 70_3 are valid periods for voice data because the data frequency is high. On the other hand, a period 72 is outside the valid period of the voice data because the data frequency is low. That is, the voice data in a period 72 is excluded from the creation of the normal time model. Moreover, a case where the data frequency is low refers to a case where the person 6 speaks little. Thus, when the data frequency is low, it is preferable that the abnormal condition detection system 1 encourages the person 6 to speak.

The current model generator 28 has a function of generating a current voice data model (called a “current model” in this embodiment) using current voice data. Moreover, the method by which the current model generator 28 generates the current model is not particularly limited. For example, the current model as a classifier of voice features may be generated using a known method by performing opportunistic learning with a waveform histogram of voice data as input and not using training data for the model.

The multiplexer 30 has a function of taking as input the current model generated by the current model generator 28, and outputting data in which voice data with low data frequency has been excluded as outliers from the normal time voice data based on the measurement results of the data frequency and data accumulation level measurer 26.

The normal time model generator 32 has a function of generating a model of the voice of the person 6 in normal times (normal time model). Moreover, the method by which the normal time model generator 32 generates the normal time model is not particularly limited, and may be the same as the method by which the current model generator 28 generates the current model, for example.

The difference detector 34 has a function of sequentially comparing the current model generator 28 with the normal time model generator 32 and outputting the comparison result. As described above, the difference detector 34 compares the waveform histogram of the current model generator 28 with the waveform histogram of the normal time model generator 32, and outputs information indicating that fact when the difference exceeds a predetermined threshold. That is, when the difference detector 34 detects a scream, it outputs information indicating that fact.

The multiplexer 36 has a function of outputting a detection result as “there is an abnormality” to the abnormal condition determiner 14 when information indicating that a scream has been detected is input from the difference detector 34. On the other hand, it has a function of outputting the detection result as “there is no abnormality” to the abnormal condition determiner 14 when no information indicating that a scream has been detected is input from the difference detector 34. Specifically, the multiplexer 36 in this embodiment outputs “1” to the abnormal condition determiner 14 in the case of “there is an abnormality” and outputs “0” in the case of “there is no abnormality”.

In this manner, the voice abnormality detector 10 may output a detection result indicating that there is an abnormality when the person 6 screams.

On the other hand, the vehicle body abnormality detector 12 includes the acceleration sensor 40, a difference detector 42, and a multiplexer 44. As described above, the acceleration sensor 40 has a function of outputting acceleration data of the vehicle 2.

The difference detector 42 has a function of sequentially outputting changes in the acceleration data as differences. The difference becomes large when the vehicle 2 has a collision or suddenly brakes. Thus, when the change (difference) in the acceleration data exceeds a predetermined threshold, the difference detector 42 outputs information indicating that an abnormality in the vehicle body 3 has been detected.

The multiplexer 44 has a function of outputting a detection result as “there is an abnormality” to the abnormal condition determiner 14 when information indicating that an abnormality in the vehicle body 3 has been detected is input from the difference detector 42. On the other hand, it has a function of outputting a detection result as “there is no abnormality” to the abnormal condition determiner 14 when no information indicating that an abnormality in the vehicle body 3 has been detected is input from the difference detector 42. Specifically, the multiplexer 44 in this embodiment outputs “1” to the abnormal condition determiner 14 in the case of “there is an abnormality” and outputs “0” in the case of “there is no abnormality.”

In this manner, the vehicle body abnormality detector 12 may output a detection result indicating that there is an abnormality when an abnormality occurs in the vehicle body 3 due to a collision of the vehicle 2 or the like.

The abnormal condition determiner 14 has a function of determining whether or not the vehicle 2 is in an abnormal condition based on the detection results of the voice abnormality detector 10 and the detection results of the vehicle body abnormality detector 12, and outputting the determination result. As an example, the abnormal condition determiner 14 of this system is an OR circuit, which outputs a determination result that the vehicle 2 is in an abnormal condition to the outside of the voice abnormality detector 10 in at least one of the cases where the detection result of the voice abnormality detector 10 is that there is an abnormality and the detection result of the vehicle body abnormality detector 12 is that there is an abnormality.

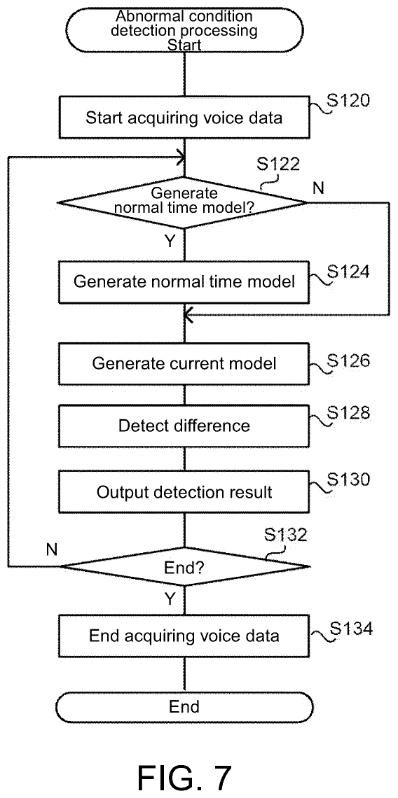

Next, the operation of the abnormal condition detection system 1 of this embodiment will be described with reference to the drawings. FIG. 6 is a flowchart showing an example of the flow of an abnormal condition detection processing executed by the CPU 51 of the controller 50. In this embodiment, the abnormal condition detection processing shown in FIG. 6 is performed by the CPU 51 executing an abnormal condition detection processing program (not shown) stored in the controller 50. As an example, in this embodiment, when the engine of the vehicle 2 is turned on, the abnormal condition detection processing shown in FIG. 6 is executed. In step S100 of FIG. 6, the CPU 51 starts processing for detecting an abnormality in the voice by the voice abnormality detector 10. Specifically, the CPU 51 starts an abnormal condition detection processing (see FIG. 7), the details of which will be described later.

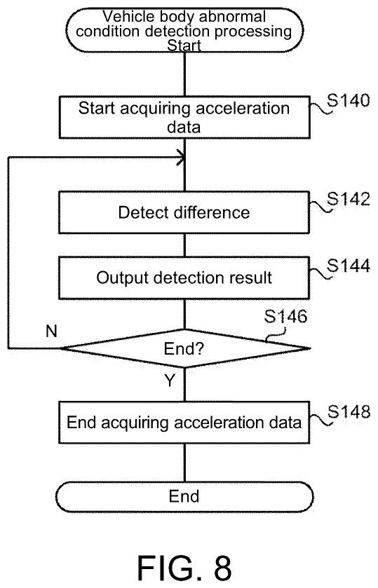

In the next step S102, the CPU 51 starts processing for detecting an abnormality in the vehicle body 3 by the vehicle body abnormality detector 12. Specifically, the CPU 51 starts a vehicle body state detection processing (see FIG. 8), the details of which will be described later.

In the next step S104, it is determined whether or not the vehicle body 3 is in an abnormal condition. In response to the detection results in steps S100 and S102, the abnormal condition determiner 14 outputs a detection result as described above. When the detection result output from the abnormal condition determiner 14 indicates that the vehicle body 3 is not in an abnormal condition, the determination in step S104 is NO, and the process proceeds to step S108. On the other hand, if it indicates that the vehicle body 3 is in an abnormal condition, the determination in step S104 is YES, and the process proceeds to step S106.

In step S106, the CPU 51 outputs, via the communication I/F 60, information that the vehicle body 3 is in an abnormal condition to the outside.

In the next step S108, the CPU 51 determines whether or not to end the abnormal condition detection processing. As an example, in this embodiment, when the engine of the vehicle 2 is turned off, the abnormal condition detection processing is ended. Thus, until the engine of the vehicle 2 is turned off, the determination in step S108 is NO, and the process returns to step S104, and the processings in steps S104 and S106 are repeated. On the other hand, when the engine of the vehicle 2 is turned off, the determination in step S108 is YES, and the abnormal condition detection processing shown in FIG. 6 ends.

Next, the above-mentioned voice abnormal condition detection processing will be described with reference to FIG. 7. FIG. 7 is a flowchart showing an example of the flow of a voice abnormal condition detection processing.

In step S120 of FIG. 7, the CPU 51 causes the voice acquirer 20 to start acquiring voice data.

In the next step S122, the CPU 51 determines whether or not to generate a normal time model. In this embodiment, a normal time model is generated at a predetermined timing. Thus, it is determined whether or not it is a predetermined timing. When a normal time model is not to be generated, the determination in step S122 is NO, and the process proceeds to step S126. On the other hand, if a normal time model is to be generated, the determination in step S122 is YES, and the process proceeds to step S124.

In step S124, the CPU 51 causes the normal time model generator 32 to generate a normal time model, as described above.

In the next step S126, the CPU 51 causes the current model generator 28 to generate a current model, as described above.

In the next step S128, the CPU 51 causes the difference detector 34 to detect the difference between the normal time model and the current model, as described above.

In the next step S130, the CPU 51 causes the detection result of the voice abnormality detector 10 to be output to the abnormal condition determiner 14.

In the next step S134, the CPU 51 determines whether or not to end the voice abnormality detection processing. As described above, until the engine of the vehicle 2 is turned off, the determination in step S132 is NO, the process returns to step S122, and the processings in steps S122 to S130 are repeated. On the other hand, when the engine of the vehicle 2 is turned off, the determination in step S132 is YES, and the process proceeds to step S134.

In step S134, the CPU 51 causes the acquisition of voice data by the voice acquirer 20 to end. When the processing of step S134 ends, the voice abnormality detection processing shown in FIG. 7 ends.

The above-mentioned vehicle body abnormal condition detection processing will be further described with reference to FIG. 8. FIG. 8 is a flowchart showing an example of the flow of the vehicle body abnormal condition detection processing.

In step S140 of FIG. 8, the CPU 51 causes the acceleration sensor 40 to start acquiring acceleration data.

In the next step S142, the CPU 51 causes the difference detector 42 to detect the difference in acceleration, as described above.

In the next step S144, the CPU 51 causes the detection result of the vehicle body abnormality detector 12 to be output to the abnormal condition determiner 14.

In the next step S146, the CPU 51 determines whether or not to end the vehicle body abnormality detection processing. As described above, until the engine of the vehicle 2 is turned off, the determination in step S146 is NO, the process returns to step S142, and the processings in steps S142 and S144 are repeated. On the other hand, when the engine of the vehicle 2 is turned off, the determination in step S146 is YES, and the process proceeds to step S148.

In step S148, the CPU 51 causes the acquisition of acceleration data by the acceleration sensor 40 to end. When the processing of step S148 is ended, the vehicle body abnormality detection processing shown in FIG. 8 is ended.

As described above, the abnormal condition detection system 1 of this embodiment includes a voice abnormality detector 10, which includes the normal time model generator 32 that generates a model of the normal time voice data of the person 6 riding in the vehicle 2 as a normal time model based on voice data including the voice of the person 6, that detects voice abnormalities based on the current voice data of the person 6 and the normal time model. Moreover, the abnormal condition detection system 1 includes a vehicle body abnormality detector 12 that detects an abnormality in the vehicle body 3 of the vehicle 2 based on the acceleration data of the vehicle 2. Further, the abnormal condition detection system 1 includes the abnormal condition determiner 14 that determines whether or not the vehicle 2 is in an abnormal condition based on the detection results of the voice abnormality detector 10 and the detection results of the vehicle body abnormality detector 12.

According to the above configuration, normal voice is acquired while the person 6 is riding in the vehicle 2, and a scream may be detected based on the normal voice. Thus, according to the abnormal condition detection system 1 of the embodiment, an abnormal condition of the vehicle can be detected without preparing scream data in advance.

The following supplementary notes are further disclosed regarding the above embodiment.

### APPENDIX 1

An abnormal condition detection system, including:
a voice abnormality detector that includes a normal time model generator for generating a model of normal time voice data of a person riding in a vehicle as a normal time model based on voice data including voice of the person, and detects an abnormality in the voice based on a current voice data of the person and the normal time model;
a vehicle body abnormality detector that detects an abnormality in a vehicle body of the vehicle based on acceleration data of the vehicle; and
an abnormal condition determiner that determines whether or not the vehicle is in an abnormal condition based on a detection result of the voice abnormality detector and a detection result of the vehicle body abnormality detector.

### APPENDIX 2

The abnormal condition detection system according to appendix 1,
wherein the voice abnormality detector further includes a current model generator for generating a model of the current voice data of the person as a current model from the current voice data of the person, and determines that the voice is abnormal when it is determined that the current voice data of the person contains a scream based on a comparison result between the current model and the normal time model.

### APPENDIX 3

The abnormal condition detection system according to appendix 1 or 2,
wherein the voice abnormality detector determines that the voice is abnormal when it is determined that the current voice data of the person contains a scream based on a comparison result between a waveform histogram obtained from the normal time voice data and a waveform histogram obtained from the current voice data.

### APPENDIX 4

The abnormal condition detection system according to any one of appendixes 1 to 3,
wherein the abnormal condition determiner determines that the vehicle is in an abnormal condition in at least one of the following cases: a case where the detection result of the voice abnormality detector indicates that the voice is abnormal and a case where the detection result of the vehicle body abnormality detector inducts that the vehicle body is abnormal.

### APPENDIX 5

An abnormal condition detection method, including:
by a processor included in an abnormal condition detection system,
generating a model of normal time voice data of a person riding in a vehicle as a normal time model based on voice data including voice of the person, and detecting an abnormality in the voice based on a current voice data of the person and the normal time model;
detecting an abnormality in a vehicle body of the vehicle based on acceleration data of the vehicle; and
outputting, based on a detection result of the abnormality in the voice and a detection result of the abnormality in the vehicle body, a determination result as to whether or not the vehicle is in an abnormal condition.

### APPENDIX 6

An abnormal condition detection recording medium, recording a program for causing a processor included in an abnormal condition detection system perform the following processing:
generating a model of normal time voice data of a person riding in a vehicle as a normal time model based on voice data including voice of the person, and detecting an abnormality of the voice based on a current voice data of the person and a normal time model;
detecting an abnormality in a vehicle body of the vehicle based on acceleration data of the vehicle; and
outputting, based on a detection result of the abnormality in the voice and a detection result of the abnormality in the vehicle body, a determination result as to whether or not the vehicle is in an abnormal condition.

What is claimed is:

1. An abnormal condition detection system, comprising:
a voice abnormality detector that comprises a normal time model generator for generating a model of normal time voice data of a person riding in a vehicle as a normal time model based on voice data including voice of the person, and detects an abnormality in the voice based on a current voice data of the person and the normal time model;
a vehicle body abnormality detector that detects an abnormality in a vehicle body of the vehicle based on acceleration data of the vehicle; and
an abnormal condition determiner that determines whether or not the vehicle is in an abnormal condition based on a detection result of the voice abnormality detector and a detection result of the vehicle body abnormality detector.

2. The abnormal condition detection system according to claim 1,
wherein the voice abnormality detector further comprises a current model generator for generating a model of the current voice data of the person as a current model based on the current voice data of the person, and determines that the voice is abnormal when it is determined that the current voice data of the person contains a scream based on a comparison result between the current model and the normal time model.

3. The abnormal condition detection system according to claim 1,
wherein the voice abnormality detector determines that the voice is abnormal when it is determined that the current voice data of the person contains a scream based on a comparison result between a waveform histogram obtained from the normal time voice data and a waveform histogram obtained from the current voice data.

4. The abnormal condition detection system according to claim 1,
wherein the abnormal condition determiner determines that the vehicle is in an abnormal condition in at least one of the following cases: a case where the detection result of the voice abnormality detector indicates that the voice is abnormal and a case where the detection result of the vehicle body abnormality detector indicates that the vehicle body is abnormal.

5. An abnormal condition detection method, comprising:
by a processor included in an abnormal condition detection system,
generating a model of normal time voice data of a person riding in a vehicle as a normal time model based on voice data including voice of the person, and detecting an abnormality in the voice based on a current voice data of the person and the normal time model;
detecting an abnormality in a vehicle body of the vehicle based on acceleration data of the vehicle; and
outputting, based on a detection result of the abnormality in the voice and a detection result of the abnormality in the vehicle body, a determination result as to whether or not the vehicle is in an abnormal condition.

6. The abnormal condition detection method according to claim 5, further comprising:
generating a model of the current voice data of the person as a current model based on the current voice data of the person, and determining that the voice is abnormal when it is determined that the current voice data of the person contains a scream based on a comparison result between the current model and the normal time model.

7. The abnormal condition detection method according to claim 5, further comprising:
determining that the voice is abnormal when it is determined that the current voice data of the person contains a scream based on a comparison result between a waveform histogram obtained from the normal time voice data and a waveform histogram obtained from the current voice data.

8. The abnormal condition detection method according to claim 5, further comprising:
determining that the vehicle is in an abnormal condition in at least one of the following cases: a case where the detection result of the voice abnormality detector indicates that the voice is abnormal and a case where the detection result of the vehicle body abnormality detector indicates that the vehicle body is abnormal.

9. An abnormal condition detection recording medium, recording a program for causing a processor included in an abnormal condition detection system perform the following processing:
generating a model of normal time voice data of a person riding in a vehicle as a normal time model based on voice data including voice of the person, and detecting an abnormality in the voice based on a current voice data of the person and the normal time model;
detecting an abnormality in a vehicle body of the vehicle based on acceleration data of the vehicle; and
outputting, based on a detection result of the abnormality in the voice and a detection result of the abnormality in the vehicle body, a determination result as to whether or not the vehicle is in an abnormal condition.

10. The abnormal condition detection recording medium according to claim 9, recording the program for causing the processor included in the abnormal condition detection system perform the following further processing:
generating a model of the current voice data of the person as a current model based on the current voice data of the person, and determining that the voice is abnormal when it is determined that the current voice data of the person contains a scream based on a comparison result between the current model and the normal time model.
